(19) United States
(12) Patent Application Publication
(10) Pub. No.: US 2026/0221130 A1
(43) Pub. Date: Jul. 30, 2026

(54) SYNTHETIC TRAINING DATA GENERATION FOR MULTI-SPEAKER TEXT-TO-SPEECH MODELS

(71) Applicant: Oracle International Corporation, Redwood Shores, CA (US)

(72) Inventors: Vishal Gourav, Bengaluru (IN); Astik Biswas, Kolkata (IN); Ankit Tyagi, Bangalore (IN); Ananya Dabas, Gurgaon (IN); Phanindra Vittal Rao Mankale, Bengaluru (IN)

(73) Assignee: Oracle International Corporation, Redwood Shores, CA (US)

(21) Appl. No.: 19/038,146

(22) Filed: Jan. 27, 2025

(51) Int. Cl. G10L 13/047

(52) U.S. Cl. CPC G10L 13/047

(57) ABSTRACT

Techniques discussed herein relate to generating synthetic training data with which a multi-speaker Text-To-Speech model may be trained. Text and an audio sample of a speaker may be provided as input to a voice generation system (VGS). The VGS may generate, based on audio features of the audio sample, machine-generated audio comprising a synthetic voice providing the text as spoken words. A synthetic training example including the machine-generated audio may be generated and combined with synthetic training data examples corresponding to a second speaker (and/or with training data examples comprising recordings of a second speaker). A multi-speaker Text-To-Speech model may be trained with a training set comprising the synthetic training data examples to generate subsequent audio that provides spoken words of input text in a synthetic voice that is generated to replicate features associated with one of a plurality of speakers comprising the first speaker and the second speaker.

### BACKGROUND

Text-To-Speech (TTS) technology is one of the most sought after technology in today’s fast moving Artificial Intelligence world. Text-To-Speech models (e.g., models that can convert written text to spoken audio) can be used for a variety of purposes including, but not limited to, creating podcasts and/or voice-overs, using speech synthesis to streamline customer service and/or feedback processes, or the like. To train a TTS model, an abundance of high quality voice data is needed (e.g., voice data that has quality phonetic coverage for a target language). However, high quality, multi-speaker data sets are difficult to find. Embodiments described herein address these and other problems, individually and collectively.

### BRIEF SUMMARY

Techniques are provided for disclosed for generating a synthetic data set with which a multi-speaker TTS model may be trained. Various embodiments are described herein, including methods, systems, non-transitory computer-readable storage media storing programs, code, or instructions executable by one or more processors, and the like.

One embodiment is directed to a method. The method may comprise providing, by the computing system to a voice generation system, input data comprising a text instance of a plurality of text instances and the audio sample corresponding to a first speaker. The method may comprise obtaining, by the computing system from the voice generation system, machine-generated audio corresponding to the first speaker. In some embodiments, the machine-generated audio may be generated based at least in part on the audio sample corresponding to the first speaker. The method may comprise generating, by the computing system, a synthetic training data set comprising the machine-generated audio generated by the voice generation system and corresponding to the first speaker with an audio recording corresponding to a second speaker. The method may comprise training, by the computing system and based at least in part on the synthetic training data set, a multi-speaker Text-To-Speech model to generate audio output comprising speech corresponding to subsequent text provided as subsequent input data.

In some embodiments, the machine-generated audio is generated by the voice generation system using a machine learning model that is configured to generate, from written text, a digital replication of a speaker’s voice. In some embodiments, the machine learning model is configured with voice cloning capabilities.

In some embodiments, the method may comprise executing, by the computing system, a first set of operations that transform text of the synthetic training data examples into corresponding sets of sound units. The method may comprise executing, by the computing system, a second set of operations that generate a respective feature vector corresponding to a respective synthetic training data example of the synthetic training data examples. The respective feature vector corresponding to the respective synthetic training data example may be utilized for the training of the multi-speaker Text-To-Speech model.

In some embodiments, the method may comprise executing, by the computing system, a first set of operations that transform text of the synthetic training data examples into corresponding sets of sound units. The method may comprise executing, by the computing system, a second set of operations that generate one or more prosody features of at least one audio sample of the synthetic training data examples. The corresponding sets of sound units and prosody features may be utilized for the training of the multi-speaker Text-To-Speech model.

In some embodiments, the method may comprise providing, by the computing system to a machine-learning model, the machine-generated audio generated by the voice generation system and corresponding to the first speaker. In some embodiments, the machine-learning model provides an audio sample duration corresponding to the machine-generated audio generated by the voice generation system and corresponding to the first speaker. In some embodiments, the audio sample duration is further utilized for the training of the multi-speaker Text-To-Speech model.

In some embodiments, the audio recording corresponding to the second speaker is one of a plurality of audio recordings corresponding to the second speaker. In some embodiments, the audio recording comprises a voice of the second speaker reading a text passage aloud.

In some embodiments, the method may comprise obtaining, by the computing system, one or more quality-related metrics corresponding to the audio output generated by the multi-speaker Text-To-Speech model based at least in part on being provided the subsequent input data. The method may comprise determining, by the computing system that the one or more quality-related metrics indicate that the audio output generated by the multi-speaker Text-To-Speech model breaches a predefined quality threshold. The method may comprise performing, by the computing system, operations to update the multi-speaker Text-To-Speech model based at least in part on an additional training data example comprising the audio output generated by the multi-speaker Text-To-Speech model.

Another embodiment comprises a system comprising one or more processors and one or more memories storing computer-executable instructions that, when executed by the one or more processors, cause the one or more processors to perform any of the methods disclosed herein.

Yet another embodiment comprises a computer-readable medium comprising or more memories storing computer-executable instructions that, when executed by one or more processors of a computing device, cause the one or more processors to perform any of the methods disclosed herein.

### BRIEF DESCRIPTION OF THE DRAWINGS

FIG. 1 is a block diagram illustrating an example Text-To-Speech processing pipeline, in accordance with at least one embodiment;

FIG. 2 is a block diagram illustrating another example Text-To-Speech processing pipeline, in accordance with at least one embodiment.

FIG. 3 is a block diagram illustrating an example method for generating synthetic training data with which a multi-speaker Text-To-Speech model may be trained, in accordance with at least one embodiment.

FIG. 4 is a simplified block diagram illustrating an example process for training a machine learning model (e.g., a Text-To-Speech model) using a semi-supervised approach, in accordance with at least one embodiment;

FIG. 5 is a table illustrating example data with which the quality of a TTS model may be assessed, in accordance with at least one embodiment;

FIG. 6 is a block diagram illustrating an example method for generating a synthetic data set with which a multi-speaker Text-To-Speech model may be trained, in accordance with at least one embodiment.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

As described above, Text-To-Speech models (e.g., models that can convert written text to spoken audio) can be used for a variety of purposes in a variety of different contexts. Multi-speaker Text-To-Speech models (e.g., models that are trained with quality voice data over many speakers) are more desirable than single-speaker Text-To-Speech models (e.g., models that are trained with quality voice data of a single speaker) in certain contexts. Multi-speaker trained Text-To-Speech models perform better than single-speaker trained models as they produce more natural-sounding speech more reliably and can often adapt to different speaking styles better than single-speaker trained model. To adequately train a TTS model, an abundance of high quality voice data is needed. High quality voice data (referred to herein as “gold-standard data”) refers to voice data that has quality phonetic coverage for the target language (e.g., the language in which the spoken audio is provided). Obtaining high quality voice data for a single voice is time consuming and expensive to generate or procure. For this reason, access to multi-speaker data sets that include high quality voice data is unavailable and such data sets are time consuming and expensive to generate. As a result, many conventional TTS models are trained with audio examples provided in a single voice. Therefore, the lack of available high quality, multi-speaker data sets negatively affects the ability to adequately train a robust, multi-speaker TTS model.

The disclosed techniques are directed to generating synthetic, multi-speaker data sets with which Text-To-Speech model training may be improved. A predefined speech data set (e.g., LJSPeech data set, etc.) may be used to obtain a variety of high quality audio recordings of a single speaker reading examples of written text (e.g., a speaker reading passages from a book, etc.). The speech data set examples (referred to herein as “gold-standard data”) may individually include written text and a corresponding audio recording of a single human speaker reading aloud the corresponding written text. A voice generation system/model (e.g., an artificial intelligence system/model that is configured to generate a digital replica of a speaker’s voice from written text or through voice cloning techniques) may be used to generate synthetic voice data with which a multi-speaker TTS model training data set may be augmented. By way of example, written text examples obtained from the speech data set may be provided as input along with an audio sample of human or synthetic speech (referred to as an “audio speech sample”). Any suitable number of written text examples paired with a variety of audio speech samples may be provided to the voice generation system, which in turn may generate synthetic data examples in a variety of voices having similar features as the voices of the audio speech samples. These synthetic data examples (also referred to as “synthetic voice data” or “silver-standard data”) may include the written text and audio comprising a synthetic voice speaking the written text aloud, as generated by the voice generation system. In some embodiments, a multi-speaker TTS model may be subsequently trained using the silver-standard data to improve the robustness of the resultant model. In some embodiments, the silver-standard data may be combined with any suitable gold-standard data to train the multi-speaker TTS model.

The disclosed techniques provide a solution to the difficulties associated with obtaining data of sufficient quality and in the amount needed for adequately training multi-speaker TTS models. Conventional single-speaker and multi-speaker TTS models suffer from the inability to robustly generate spoken audio from written text due to the lack of high quality voice data. Single-speaker TTS models fail to produce audio of the quality that multi-speaker TTS models are capable of producing. Furthermore, conventional multi-speaker TTS model training suffers due to lack of quality voice data access and the difficulties associated with generating such data. The unavailability of high quality voice data results in training process delays and makes it difficult, time consuming, and expensive to improve the accuracy, reliability, and robustness of conventional multi-speaker TTS models. As the disclosed techniques may be used to generate any suitable number of training data examples across any suitable number of disparate voices, the initial training of a multi-speaker TTS model is easier and simplified with respect to conventional methods, and the ease at which the model may be improved over time is increased.

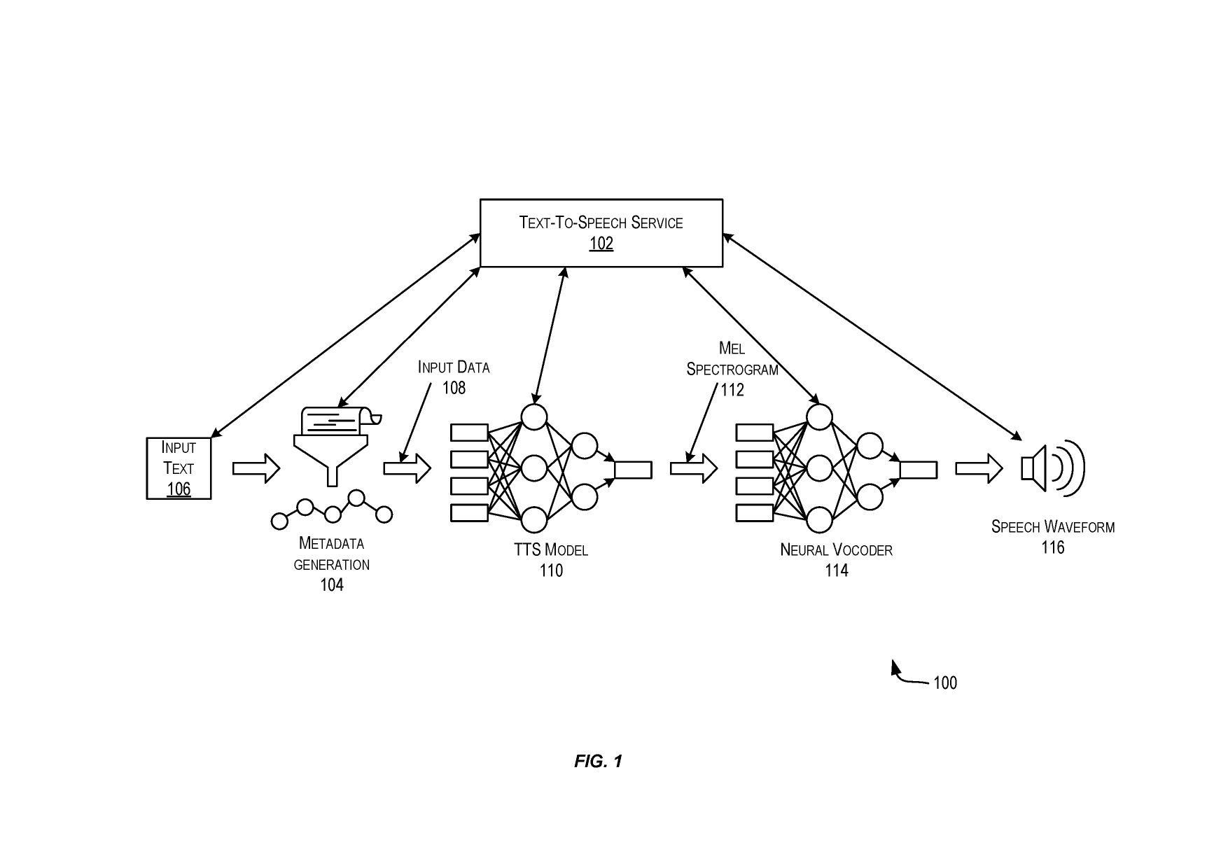

Moving on the figures, FIG. 1 is a block diagram illustrating an example Text-To-Speech (TTS) processing pipeline 100, in accordance with at least one embodiment. The operations discussed in connection to the TTS processing pipeline 100 may be executed, at least in part, by the Text-To-Speech (TTS) service 102. The TTS service 102 may be configured to interact with one or more other systems to cause any suitable portion of the TTS processing pipeline 100 to be executed. In some embodiments, the TTS service 102 may be configured to directly invoke any suitable portion of the TTS pipeline 102 based at least in part on providing input to a module of the TTS processing pipeline 102, executing a function call, transmitting data via an application programming interface, or the like. In some embodiments, the TTS Service 102 may include modules or models that provide any suitable portion of the TTS processing pipeline 100.

In some embodiments, the TTS processing pipeline 102 may generating metadata 104. Generating metadata 104 may include any suitable operations for generating any suitable metadata for input text 106. By way of example, generating metadata 104 may include performing text preprocessing operations that prepare the input text (e.g., input text 106) or otherwise generate input data to be provided to a TTS model (e.g., TTS model 110) of the TTS processing pipeline 102. In some embodiments, the TTS model 108 may be a multi-speaker TTS model that has been previously trained using a large number of written text/spoken audio examples corresponding to multiple speakers (e.g., human speakers, synthetic speakers, etc.).

Performing metadata generation 104 may include executing a Speech Synthesis Markup Language (SSML) parse of input text 106. The SSML parser (e.g., the TTS service 102 or another module) may be configured to mark the input text 106 with SSML tags that prepare the text to be provided as input to TTS model 108. Metadata generation 104 may include performing any suitable operations corresponding to text normalization and phonemic transcription. Text normalization may include any suitable form of disambiguating and expanding the natural language and/or non-standard words (e.g., dates, currencies, abbreviations, etc.) of input text 106. In some embodiments, text normalization may include generating a sequence of graphemes (letters that represent sounds in a written language). Metadata generation 104 may include executing any suitable operations associated with phonemic transcription that includes transcribing a sequence of graphemes into a sequence of phonemes or otherwise generating, from graphemes, a sequence of phonemes that represent spoken sound of the input text 106. Graphemes and phonemes are example units of sound. Phonemes are the smallest unit of sound that can distinguish one word from another. By way of example, at least a portion of the phonemes may be generated using a software program, Espeak, that has been configured to grapheme-to-phoneme conversion operations. In some embodiments, any suitable portion of the metadata generation 104 may be performed using a predefined component (e.g., a plugin, a library, an application, a software or hardware component, etc.) that has been configured to perform at least a subset of the operations discussed in connection with metadata generation 104. By way of example, at least a portion of the text normalization described above may be conducted using NeMo, a toolkit that has been previously developed for text normalization and inverse text normalization.

Input data 108 including the sequence of phoneme(s) resulting from performing metadata generation 104 may be provided to a TTS model (e.g., TTS model 110) as input. The TTS model may be a machine-learning model that has previously been trained to take a set of phoneme(s) as input and generate a corresponding Mel spectrogram (e.g., Mel spectrogram 112) as output. A Mel spectrogram may indicate frequency content of an audio signal over time. In some embodiments, the TTS model may be a neural network (e.g., Fastspeech2, Tacotron TTS, etc.) that has learned relationships between text input and corresponding audio waveforms based at least in part on being trained with written text and matching audio spectrogram examples. In some embodiment, the TTS model may include an encoder-decoder architecture in which the encoder converts the input to a data representation and generates a spectrogram (e.g., a Mel spectrogram) that may be converted into audio using a vocoder (e.g., neural vocoder 114).

In some embodiment, neural vocoder 114 may be an example of a deep-learning neural network (e.g., HiFiGAN, etc.) that has been previously trained to synthesize audio waveforms from acoustic features (e.g., a Mel spectrogram representation of an audio signal). Speech waveform 116 (e.g., synthetic audio representing a spoken version of the input text 106) may generated by neural vocoder 114 based at least in part on being providing the Mel spectrogram 112 that was generated by TTS model 110 as input to the neural vocoder 114.

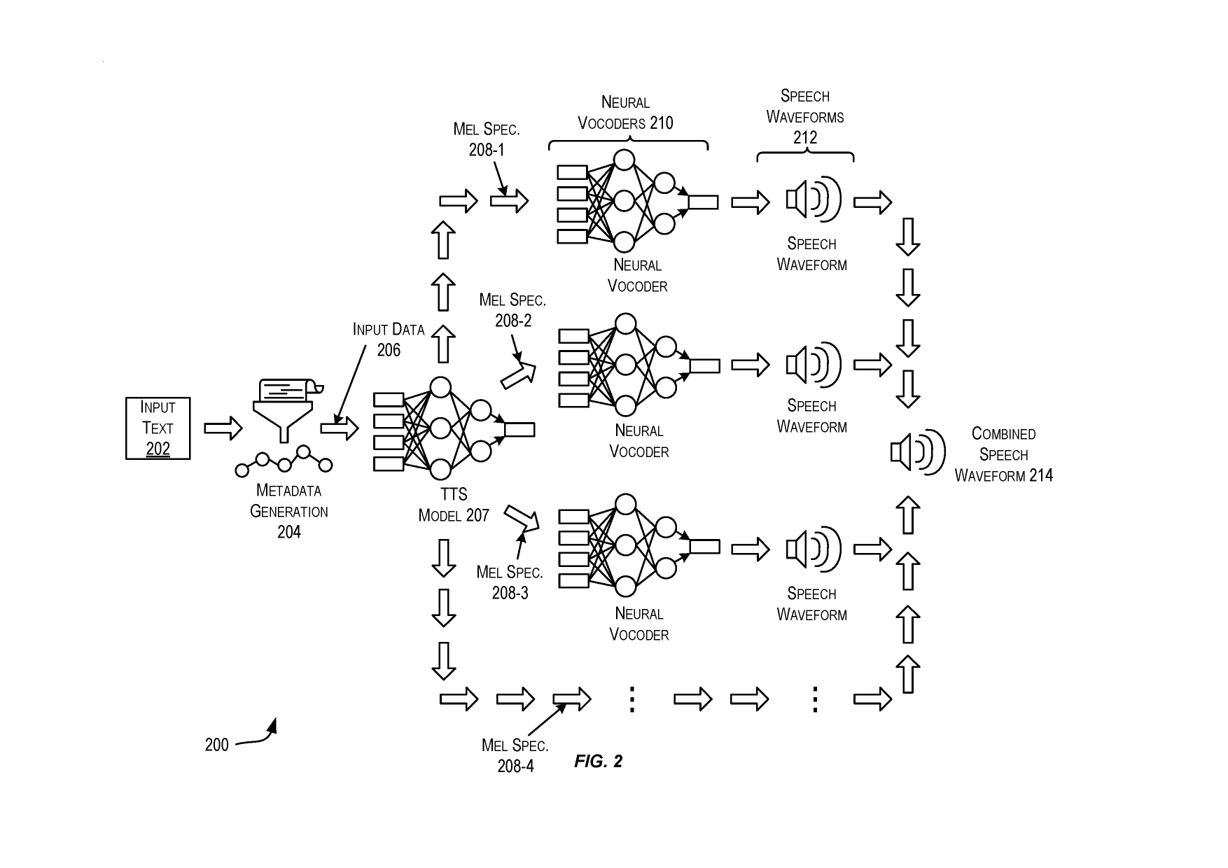

FIG. 2 is a block diagram illustrating another example Text-To-Speech pipeline (e.g., TTS pipeline 200), in accordance with at least one embodiment. TTS pipeline 200 may utilize multi-threading at the neural vocoder level to provide improved inference times in comparison to the TTS pipeline 100 of FIG. 1. The operations discussed in connection with FIG. 2 may be performed by the Text-To-Speech service 102 of FIG. 1. Input text 202 may be an example of the input text 106 of FIG. 1. Metadata generation 204 and the operations performed during metadata generation 204 may correspond to the operations discussed above in connection with metadata generation 104 of FIG. 1. TTS model 207 may be an example of TTS model 110 of FIG. 1.

Input data 206 may be generated in a similar manner as discussed in FIG. 1 by performing the operations associated with metadata generation 204 using input text 202. In this example, a set of phonemes generated from the input text 202 may be provided to TTS model 207 as input data 206. TTS model 207 may generate a Mel spectrogram corresponding to the input data 206.

The Mel spectrogram may be split (e.g., by TTS service 102 of FIG. 1) into any suitable number of Mel spectrograms that represent a smaller portion of the original Mel spectrogram. In some embodiments, TTS service 102 may split the Mel spectrogram into an equal number of portions (e.g., a number of threads available such as 2, 4, 6, or 8, depending on the processor(s) utilized by the computing device on which the TTS service 102 executes). In the example depicted in FIG. 2, Mel spectrograms 208-1, 208-2, 208-3, and 208-4 (collectively, “Mel spectrograms 208”) individually represent different portions of the Mel spectrogram generated by TTS model 207. Collectively, Mel spectrograms 208 represent the Mel spectrogram generated by TTS model 207.

Each of the Mel spectrogram segments 208 may be provided to a corresponding neural vocoder of neural vocoders 210. Each of the neural vocoders 210 may be an example of the neural vocoder 114 of FIG. 1. Each of the neural vocoders 210 may generate a corresponding speech waveform of speech waveforms 212. Speech waveforms 212 may be combined to form combined speech waveform 214 (e.g., an example of the speech waveform 116 of FIG. 1).

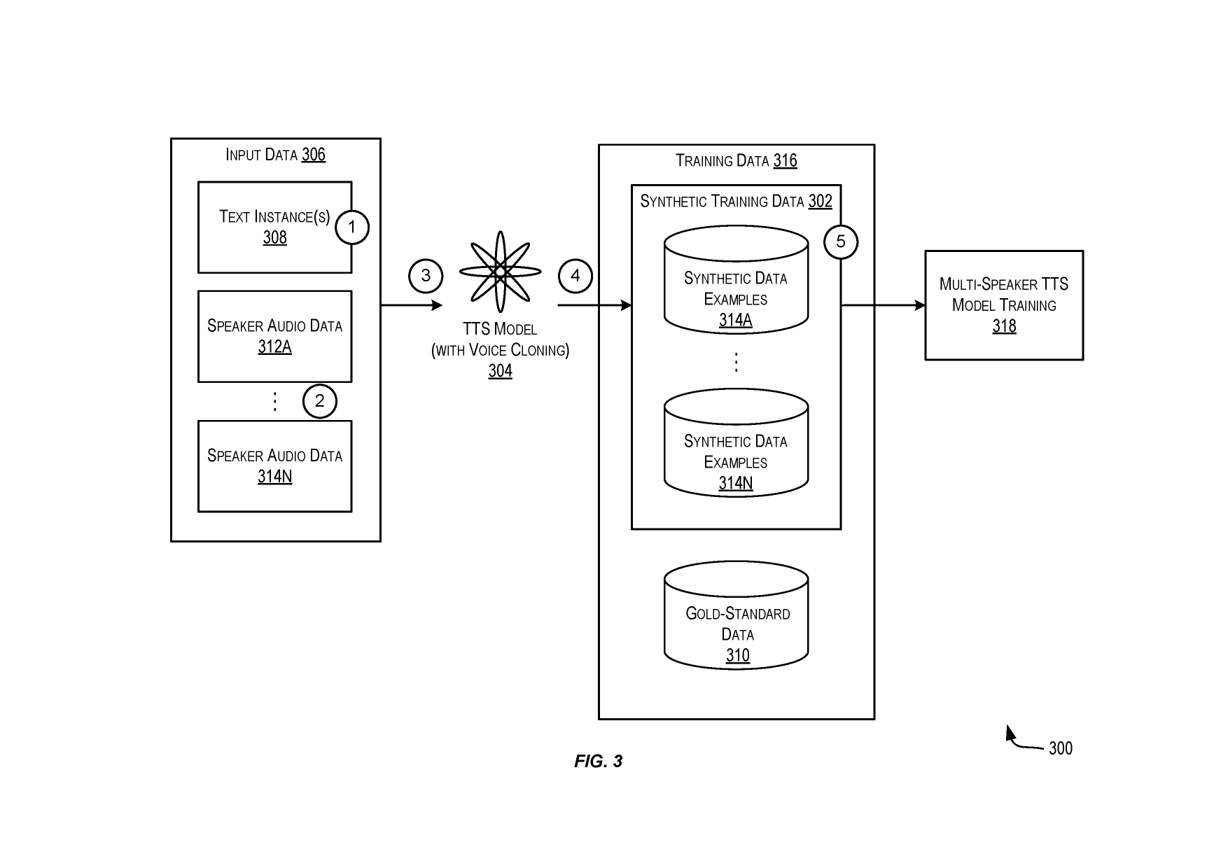

FIG. 3 is a block diagram illustrating an example method 300 for generating synthetic training data (e.g., synthetic training data 302) with which a multi-speaker Text-To-Speech model (e.g., the TTS model 110 of FIG. 1, the TTS model 207 of FIG. 2) may be trained, in accordance with at least one embodiment. The operations discussed in connection with FIG. 3 may be performed by the Text-To-Speech service 102 of FIG. 1. As depicted in FIG. 3, generating synthetic training data 302 may utilize a TTS model (e.g., TTS model 304) that is trained to generate natural-sounding speech from written text provided as input. In some embodiments, TTS model 304 may be configured with voice cloning features (e.g., the capability of using voice cloning techniques to generate audio). A TTS model configured with voice cloning features may be configured to transform audio input provided in one voice into audio provided in a different voice. Examples of TTS model 304 may include MetaVoice-1B, Tacotron 2, and similar models. In some embodiments, TTS model 304 may be configured to produce audio from input data including written text and an audio sample of a speaker. In some embodiments, the TTS model 304 uses acoustic/speech features of the audio sample to generate audio in which a synthetic voice with similar acoustic/speech features reads the text aloud.

Method 300 include generating input data 306 for TTS model 304. At step 1, text instance(s) 308) may be obtained. In some embodiments, text instance(s) 308 may include written text of any suitable length, in any suitable language. The text instance(s) 308 may be obtained (e.g., by TTS service 102) from any suitable source. In some embodiments, text instance(s) 308 may include written text examples of gold-standard data 310. Gold-standard data 310 may include written text and a corresponding audio recording of a human speaker reading the corresponding written text aloud. In some embodiments, gold-standard data 310 may be a public domain speech dataset (e.g., LJSPeech, a dataset that includes approximately 24 hours of short audio clips (e.g., 1-10 second clips) of a single speaker reading passages aloud from 7 non-fiction books). In some embodiments, Data instances of Gold-standard data 310 may include a text example and an audio in which the single speaker reads the text example aloud. In some embodiments, the text example is a transcription of the audio, but not necessarily so. In some embodiments, Gold-standard data 310 may be obtained at any suitable time and text instance(s) 308 may be generated based at least in part on obtaining any suitable portion of the text examples of Gold-standard data 310.

At step 2, any suitable number of audio data instances (e.g., speaker audio data 312A, speaker audio data 312N, collectively “speaker audio data 312”). These audio data instances may correspond to any suitable number of speakers. For example, speaker audio data 312A may correspond to a first speaker and speaker N audio data 312N may correspond to different speaker. The audio data instances (e.g., speaker audio data 312) may be any suitable duration. In some embodiments, the speaker audio data 312 may feature speakers having different vocal ranges, different accents, or otherwise disparate vocal qualities. Each of the instances of speaker audio data 312 may be paired with any suitable number of text instance(s) 308 to generate input data 306. By way of example, if text instance(s) 308 included three instances of text (e.g., text instance 1, text instance 2, and text instance 3), the speaker audio data 312A may be paired with each instance to generate three example pairs for input data 306. Similarly, the speaker audio data 312N may be paired with each of the text instance(s) 308 to generate three additional example pairs for input data 306. In some embodiments, any suitable portion of the speaker audio data 312 may be obtained from any suitable source. By way of example, in some embodiments, at least a portion of speaker audio data 312 may be obtained from a public database (e.g., a public domain audiobook provided such as Librivox). Each input pair may be associated with a speaker identifier (ID) that uniquely identifies the speaker in the audio of the input pair. In some embodiments, an example of input data 306 may include an instance of written text, an audio sample of a speaker, and a unique identifier associated with the speaker. In some embodiments, the TTS service 102 of FIG. 1 is configured to assign unique speaker identifier to each audio sample. For example, speaker audio data 312A may be associated with one identifier (e.g., “speaker 1”) and speaker audio data 312N may be associated with another identifier (e.g., “speaker 2”).

At step 3, the input data 306 comprising any suitable number of example pairs generated in the manner described above, may be provided to the TTS model 304 as input. The TTS model 304 may be configured to generate audio data in which the text of a given example is spoken in a synthetic voice. The TTS model 304 may be configured to generate the audio data based at least in part on acoustic/vocal features of the audio of the speaker that was provided in the example. In some embodiments, providing text instance(s) 308 and speaker audio data 312A pairs causes the TTS model 304 to generate synthetic data examples 314A. Similarly, providing text instance(s) 308 and speaker audio data 312N pairs may cause the TTS model 304 to generate synthetic data examples 314N.

At step 4, synthetic data examples 314A and synthetic data examples 314N may be obtained from TTS model 304. Each example of audio data of synthetic data examples 314A and synthetic data examples 314N may include the text used by the TTS model 304 to generate an audio, the audio generated by the model from the text and based on the features of the speaker audio data provided as input, and the identifier associated with the speaker (e.g., as assigned by the TTS service 102). In some embodiments, the speaker audio data provided as input to the TTS model 304 may be stored as part of the corresponding synthetic data example.

At step 5, any suitable portion of synthetic data examples 314A and/or synthetic data examples 314N (collective, “synthetic data examples 314”) may be used to generate synthetic training data 302. In some embodiments, examples of gold-standard data 310 may be assigned a speaker identifier that uniquely identifies the speaker of the audio examples of gold-standard data 310. Training data 316 may include any suitable combination of any suitable portion of synthetic data examples 314 and/or any suitable number of examples corresponding to gold-standard data 310. Each example of training data 316 may include text, audio in which the text is read aloud, and a speaker identifier that uniquely identifies the speaker featured in the audio (e.g., a human speaker as provided in the examples of gold-standard data 310, or a computer-generated voice as provided in the examples of synthetic training data 302).

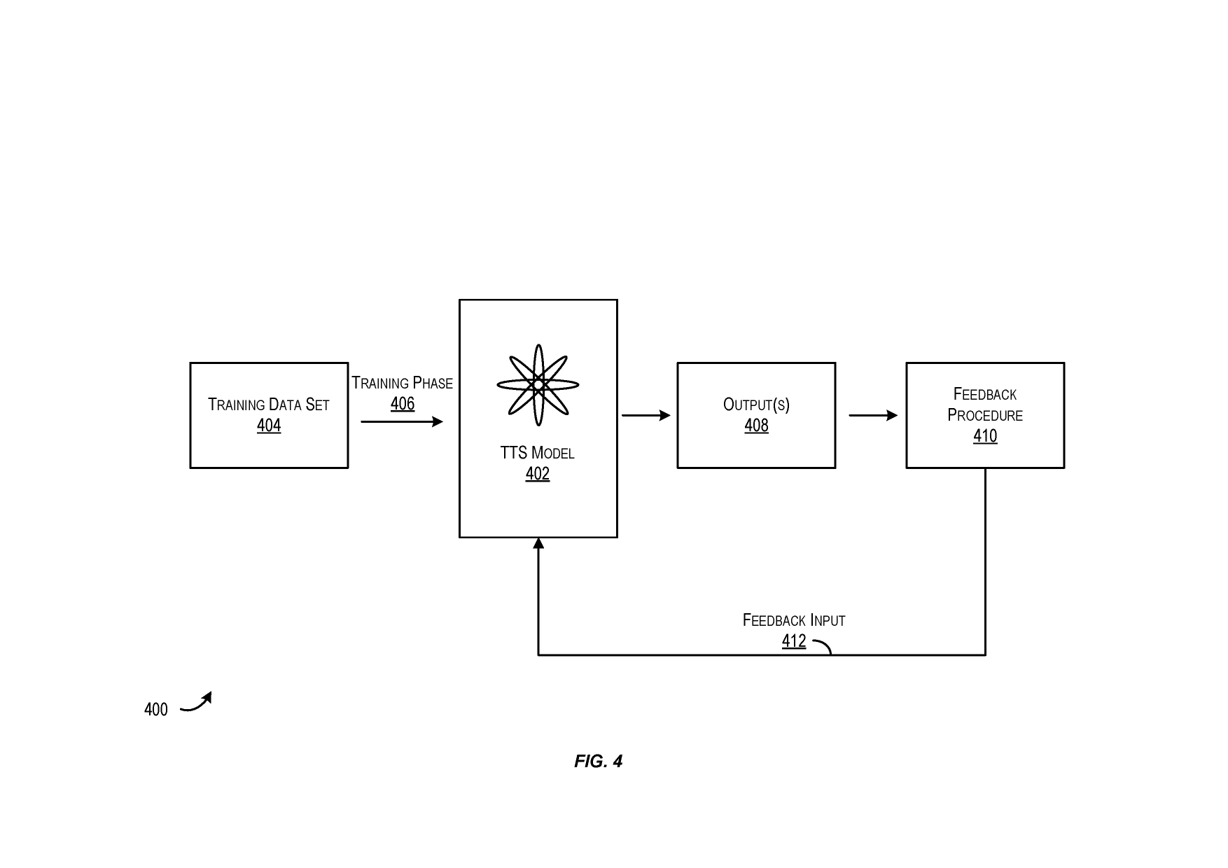

At step 6, multi-speaker TTS model training 318 may be performed to train a multi-speaker model (e.g., the TTS model 110 of FIG. 1). Example training operations are discussed in further detail with respect to FIG. 4.

FIG. 4 is a simplified block diagram illustrating an example method 400 for training machine learning model (e.g., Text-To-Speech (TTS) model 402) using a semi-supervised approach, in accordance with at least one embodiment. In some embodiments, the TTS model 4 is an example of TTS model 110 of FIG. 1 and/or TTS model 202 of FIG. 2. Any suitable operations described in connection with FIG. 4 may be performed by the TTS service 102 of FIG. 1.

In some embodiments, training data set 404 (e.g., training data 316 of FIG. 3) may be augmented with metadata. As a non-limiting example, any suitable portion of the operations discussed above in connection with metadata generation 104 of FIG. 1 may be similarly performed prior to conducting training phase 406. By way of example, the text for each example may be converted/transformed to phoneme sequences by replacing words (corresponding to graphemes) to corresponding phoneme sequences. The resulting phoneme sequence may be an example of input provide in Kaldi format.

In some embodiments, pitch and energy data may be generated for each of the examples in training data set 404. By way of example, in some embodiments, the speaker audio data corresponding to a given example (e.g., speaker audio data 312A of FIG. 3, speaker audio data 314N of FIG. 3, etc. ) may be to a neural network for feature extraction. As a non-limiting example, the neural network (e.g., ESPnet, etc.) may be a pre-trained deep learning model that is configured to extract a speaker embedding (e.g., referred to as an “x-vector”) that represents unique characteristics of a speaker’s voice. The audio of a given training data set example may be converted into a suitable feature representation (e.g., mel-filter bank) and provided as input to a pre-trained x-vector extraction model (e.g., ESPnet), which in turn may output a fixed-length vector (e.g., an x-vector) that indicates various characteristics of speaker’s voice. In some embodiments, these characteristics may include prosody features such as pitch and energy. Pitch may be represented as a sequence of log-F0 values, corresponding to the fundamental frequency for each frame of the speech. Energy may be represented as a sequence of normalized energy values reflecting the loudness at each frame of the speech.

In some embodiments, a duration associated with each example audio in the training data set 404 may be generated. As a non-limiting example, pretrained Text-To-Speech model (e.g., a TTS model such as Tacotron, not depicted) may be used to generate audio duration and other features of an audio provided as input. Any suitable combination of the features discussed above (e.g., pitch, energy, audio duration) may be stored as part of the training data set 404 and provided as part of a training data set example that includes the corresponding text, audio, and speaker identifier. In some embodiments, prosody features (e.g., pitch and energy) and/or duration may be used as targets for the output(s) 408.

TTS model 402 may be trained during training phase 406 using training data set 404 and any suitable machine learning supervised learning algorithm. A supervised machine learning algorithm refers to a machine learning task that includes learning an inferred function that maps an input (e.g., any suitable combination of written text, corresponding audio in which the text is spoken, speaker identifier, pitch, energy, and audio duration) to an output (e.g., output(s) 408) based on a labeled training data set for which example input/output pairs are known (e.g., training data set 404). An example of output(s) 408 may include a Mel spectrogram, such as Mel spectrogram 112 of FIG. 1, Mel spectrogram 208 of FIG. 2, and the like. In some embodiments, TTS model 402 may combine TTS model 110 of FIG. 1 and the neural vocoder 114 of FIG. 1. Therefore, in some embodiments, TTS model 402 may be trained during training phase 406 to learn to map input examples to corresponding output(s) 408 that include a corresponding speech waveform (e.g., speech waveform 116). As a non-limiting example, the training phase 206 may include executing operations that are associated with a Joint Conformer Fastspeech2 HiFiGAN training algorithm.

TTS model 402 may generate output(s) 408 (e.g., Mel spectrograms, speech waveforms, etc.) associated with any suitable number of examples of training data set 404. Any suitable portion (e.g., 80%) of training data set 404 may be used for training during the training phase 406. At any suitable time, the quality of TTS model 402 may be evaluated. In a non-limiting example, the accuracy/quality of TTS model 402 may be assessed using output (e.g., output(s) 408) corresponding to another portion of the training data set 404 (e.g., 10% of training data set 404 that has not been used during training phase 406). An example from this test portion of the training data set 404 (e.g., an example including text, audio of a speaker (real or synthetic) reading the text aloud, speaker pitch/energy features corresponding to the audio, speaker identifier, and audio duration) may be provided to the TTS model 402 to produce a corresponding output (e.g., a Mel spectrogram when TTS model 402 does not include a neural vocoder, or a speech waveform when TTS model 402 includes a neural vocoder, etc.). If output(s) 408 are in Mel spectrogram form, the output(s) 408 may be provided to a neural vocoder (e.g., neural vocoder 114 of FIG. 1) prior to executing the feedback procedure 410, in order to utilize the corresponding speech waveforms for the feedback procedure 410.

Assessing the accuracy and/or quality of the current TTS model 402 may include performing operations associated with feedback procedure 410. This may include comparing the audio generated by TTS model 402 to the audio provided as input to the TTS model 402 and assessing differences between the two (e.g., mismatching words, accents, vocal features, pitch, flow, etc.).

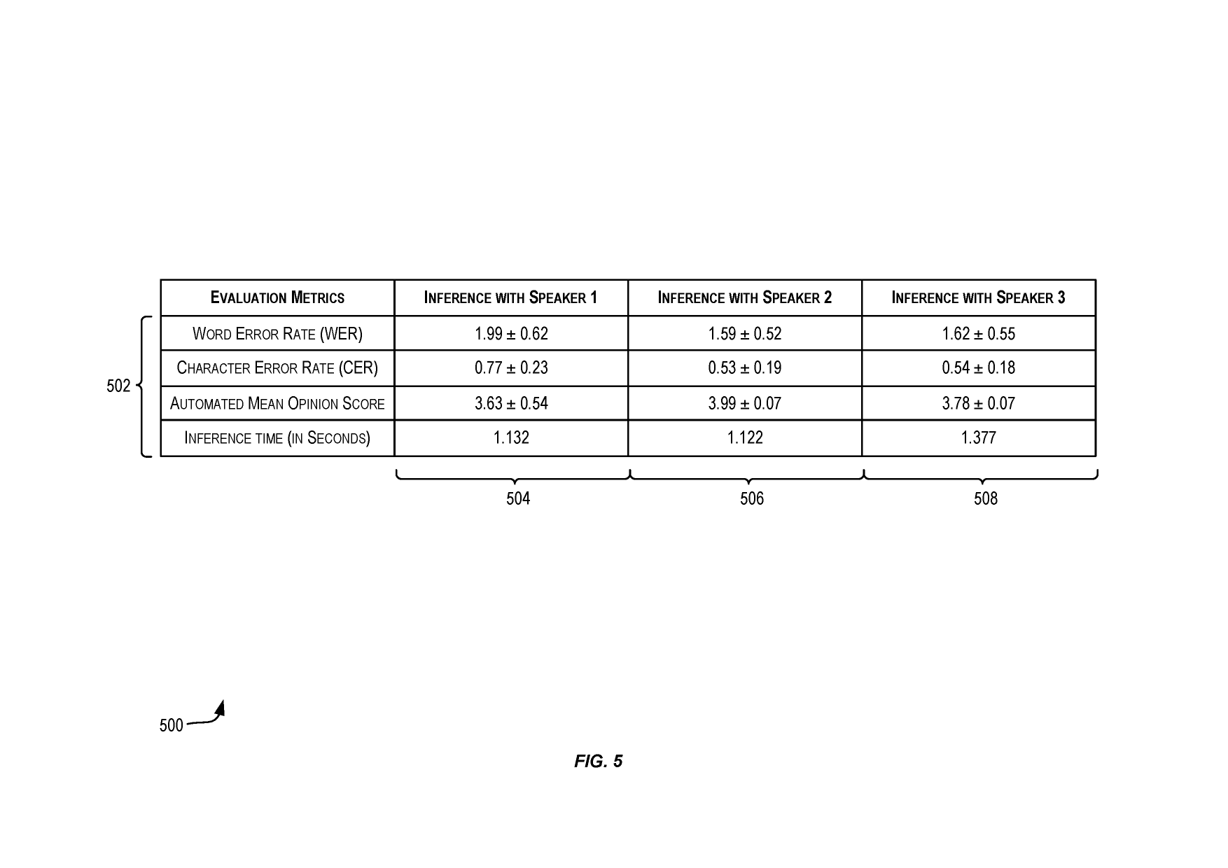

In some embodiments, feedback procedure 410 may include identifying (e.g., provided as part of output(s) 408 or otherwise obtained from TTS model 402, or calculating) evaluation metrics such as a Word Error Rate (WER), a Character Error Rate (CER), an Automated Mean Opinion Score (A-MOS) or other quality score, and/or an inference time that is associated with a given output and/or across examples that are associated with a speaker identifier. Word Error Rate (WER) refers to a ratio of incorrect words of the speech generated using the TTS model 402 to the total number of words of the text of the corresponding training data set example. Character Error Rate (CER) refers to a ratio of incorrect characters of the text corresponding to the speech generated using the TTS model 402 with respect to the total number of characters of the test of the corresponding training data set example. Any suitable number of evaluation metrics corresponding to any suitable number of examples that are associated with a speaker identifier may be used to generate a metric that represents a WER, a CER, or an A-MOS across all (or at least multiple) examples that correspond to the same speaker identifier. Examples of such metrics are provided in FIG. 5.

FIG. 5 is a table 500 illustrating example data with which the quality of a TTS model may be assessed, in accordance with at least one embodiment. Table 500 includes rows 502, which individually correspond to difference evaluation metrics such as Word Error Rate (WER), Character Error Rate (CER) Automated Mean Opinion Score (A-MOS), and inference time (in seconds). In the ongoing example provided in the above figures, columns 504-508 provide corresponding values for respective speakers/speaker identifiers. For example, column 504 provides the evaluation metric values corresponding to “speaker 1,” column 506 provides the evaluation metric values corresponding to “speaker 2,” and column 508 provides the evaluation metric values corresponding to “speaker 3.” Each value of columns 504-508 and rows 502 may be a mean, average, or another suitable combination across any suitable number of examples associated with a particular speaker.

Returning to FIG. 4, in some embodiments, any suitable portion or combination of the evaluation metrics described in connection with FIG. 5, may be generated based at least in part on user input obtained during feedback procedure 410. By way of example, output(s) 408 may be presented with the text, the speaker audio data of the corresponding example, and the speech waveform generated by the TTS model 402 (or the speech waveform generated from the Mel spectrogram generated by the TTS model 402), to any suitable number of users in order to solicit feedback from which at least some of the evaluation metrics (e.g., WER, CER, A-MOS) may be generated.

In some embodiments, a Speech-To-Text (STT) model (e.g., a machine learning model trained to generated text from corresponding speech) may be used to generate text from the audio generated by the TTS model 402 (or the speech waveform generated from the Mel spectrogram generated by the TTS model 402). The user input obtained during feedback procedure 410 may indicate any suitable word error (e.g., indicating a quantity of word errors between 1) the example text and the text generated by the STT model from the audio generated by the TTS model 402, or 2) the example text and words spoken during the audio generated by the TTS model 402). The user input obtained during feedback procedure 410 may indicate any suitable character error (e.g., indicating a quantity of character errors between the example text and the text generated by the STT model from the audio generated by the TTS model 402). The user input obtained during feedback procedure 410 may indicate any quality score assigned by the user to a particular output of output(s) 408. In some embodiments, a machine learning model (not depicted) may be trained to assign a quality score based at least in part on quality scores assigned by users and corresponding to historical examples and outputs generated by the TTS model 402. In this manner, the model may be used to generate an A-MOS for the output(s) 408.

In some embodiments, the TTS service 102 may generate the WER values corresponding to each speaker identifier based at least in part on computing the ratio of incorrect (mismatching) words of the speech generated using the TTS model 402 to the total number of words of the text of the corresponding training data set example. In some embodiments, the WER for many examples corresponding to the same speaker identifier may be combined (e.g., averaged) and/or a mean may be identified and used to assess the quality of the TTS model 402.

In some embodiments, the TTS service 102 may generate the CER values corresponding to each speaker identifier based at least in part on computing the ratio of incorrect (mismatching) characters of the speech generated using the TTS model 402 to the total number of characters of the text of the corresponding training data set example. In some embodiments, the CER for many examples corresponding to the same speaker identifier may be combined (e.g., averaged) and/or a mean may be identified and used to assess the quality of the TTS model 402.

In some embodiments, the evaluation metrics may be for one or more speakers may be utilized to assess the quality of a particular output and/or the TTS model 402 as a whole. If an output is identified as being of high quality (e.g., is determined to have a WER and/or CER that falls below respective threshold values, is determined to have an A-MOS or other quality score that exceeds a predefined quality threshold, etc.), the example may be provided as feedback input 412 and used to retrain or finetune the model the TTS model 402.

The evaluation metrics may be utilized with a predefined rule set to determine whether predefined quality threshold have been met based at least in part on the output(s) 408 already provided by the TTS model 402. If the output(s) 408 are deemed lack the expected quality (e.g., the metrics indicate a quality that falls below a predefined quality threshold), additional training may be performed using additional examples of the training data set 404 (e.g., 10% of the training data set 404 that is associated with finetuning the TTS model 402). This process of retraining and further assessing subsequent outputs of the TTS model 402 may be performed any suitable times as part of the feedback procedure 410, until the output(s) 408 are identified (based at least in part on the predefined rule set) to be of a quality that meets or exceeds the predefined quality threshold. When the quality of the TTS model 402 is determined to meet or exceed the predefined quality threshold, the training phase 406 may conclude. The trained TTS model 402 may be subsequently used for inference in which new examples are provided as input and used by the TTS model 402 to generate new outputs.

The training phase 406 depicted in FIG. 4 may be subsequently performed any suitable number of times at any suitable interval and/or according to any suitable schedule such that the accuracy of the machine learning model(s) 202 are improved over time.

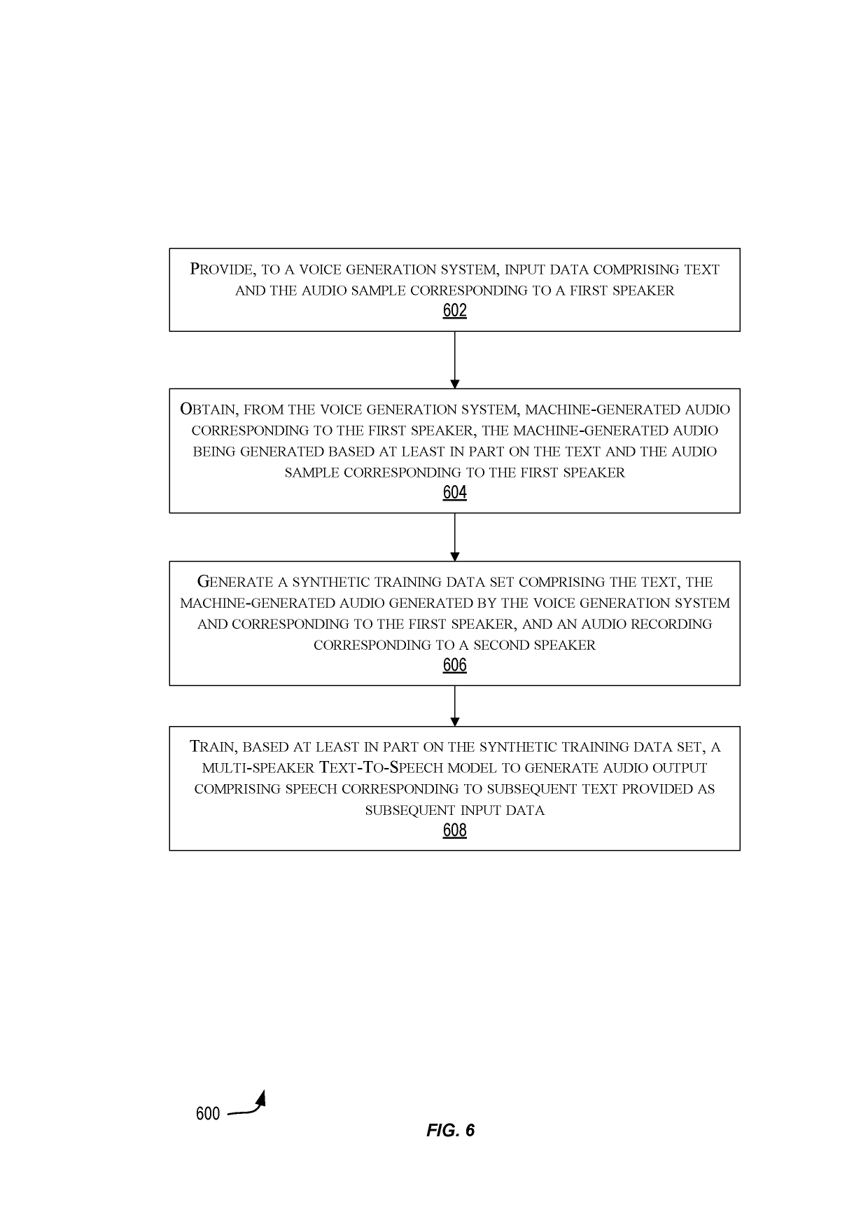

FIG. 6 is a block diagram illustrating an example method 600 for generating a synthetic data (e.g., synthetic training data 302 of FIG. 3) with which a multi-speaker Text-To-Speech (TTS) model may be trained, in accordance with at least one embodiment. The multi-speaker TTS model may be an example of TTS model 110 of FIG. 1, TTS model 207 of FIG. 2, and/or TTS model 402 of FIG. 4. The method 600 may be performed by TTS Service 102 of FIG. 1. In some embodiments, the method 600 may include more or fewer steps than the number depicted in FIG. 6. It should be appreciated that the steps of method 600 may be performed in any suitable order.

The method 600 may begin at 602, where input data comprising text and the audio sample corresponding to a first speaker may be provided to a voice generation system (e.g., TTS model 304 of FIG. 3). The first speaker (a “target speaker”) may be a speaker that is associated with a set of audio samples of a public database (e.g., a public domain audiobook provided such as Librivox). In some embodiments, the audio sample may be one of the set of audio samples and may be obtained from the public database. The voice generation system, in some embodiments, may include a voice cloning capability (e.g., the capability of generating, utilizing voice cloning techniques, audio of a target speaker speaking aloud words of text provided as input). The voice generation system may be configured to take input data including input text and audio of a target speaker and generate audio of the target speaker reading aloud the words of the text. In some embodiments, the text may be one of a plurality of text instances (e.g., text instance(s) 308 of FIG. 3). The text instance(s) may be obtained as part of gold-standard data 310 of FIG. 3. By way of example, the text may be one obtained from a plurality of paired examples comprising a respective text instance and an audio recording of a second speaker (e.g., a speaker associated with the gold-standard data 310) reading aloud the words of the text instance. The plurality of paired examples and/or the text may be obtained at any suitable time from any suitable source (e.g., a public domain data set such as gold-standard data 310 (e.g., LJSpeech, etc.)).

At 604, machine-generated audio corresponding to the first speaker may be obtained from a voice generation system (e.g., TTS 304). In some embodiments, the machine-generated audio may be generated by the voice generation system based at least in part on the text and the audio sample corresponding to the first speaker. As a non-limiting example, the text and the audio sample corresponding to the first speaker (e.g., a speaker corresponding to the audio sample) may be provided by the computing system to the voice generation system (e.g., the TTS model 304 of FIG. 3, a system configured to utilize TTS model 304, etc.) and used to generate the machine-generated audio. The machine-generated audio may comprise a synthetic voice reading the words of the text instance aloud.

Any suitable number of audio samples generated by the voice generation system. For example, a plurality of text instances (e.g., text instance(s) 308) and audio pairs may be provided to the voice generation system, where each pair includes different text instances of text instance(s) 308 and the same audio sample (e.g., speaker audio data 312A of FIG. 3). In response to being provided each of these pairs of data, the voice generation system may provide a plurality of audios samples that include the speaker of the audio sample reading words corresponding to a respective text instance aloud.

At 606, a synthetic training data set may be generated. In some embodiments, an example (of the synthetic training data set e.g., one of synthetic data examples 314A of FIG. 3) may comprise the text, the machine-generated audio generated by the voice generation system and corresponding to the first speaker, and an audio recording corresponding to a second speaker. In some embodiments, the synthetic training example of the plurality of synthetic training data examples may comprise the text (e.g., one of text instance(s) 308), the audio sample corresponding to the first speaker (e.g., speaker audio data 312A), and the machine-generated audio generated by the voice generation system based at least in part on the audio sample corresponding to the first speaker (e.g., a machine-generated audio of the synthetic data examples 314A).

At 614, a multi-speaker Text-To-Speech model (e.g., TTS model 304) may be trained, based at least in part on the synthetic training data set, to generate audio output (e.g., speech waveforms similar to speech waveform 116 of FIG. 1, speech waveform 214 of FIG. 2, etc.) that comprises speech corresponding to subsequent text provided as subsequent input data. In some embodiments, the audio output may be generated based at least in part on replicating features associated with one of a plurality of speakers comprising the first speaker and the second speaker. In some embodiments, the multi-speaker Text-To-Speech model may be configured to generate output (e.g., Mel spectrogram 112 of FIG. 1, Mel spectrogram 208 (Mel spectrograms 208-1, 208-2, 208-3, and 208-4, collectively) from which a speech waveform (e.g., speech waveform 116 of FIG. 1) may be generated.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

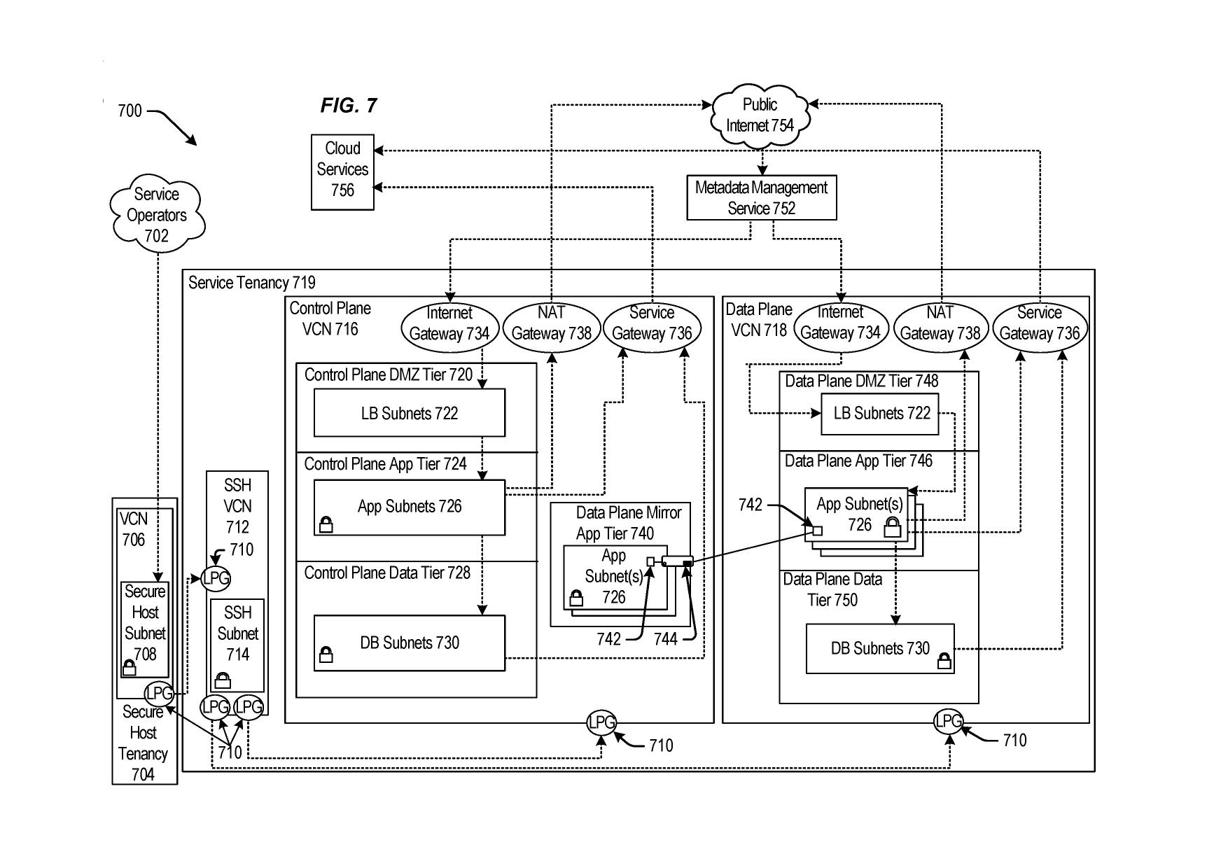

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users’, or other customers’, resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

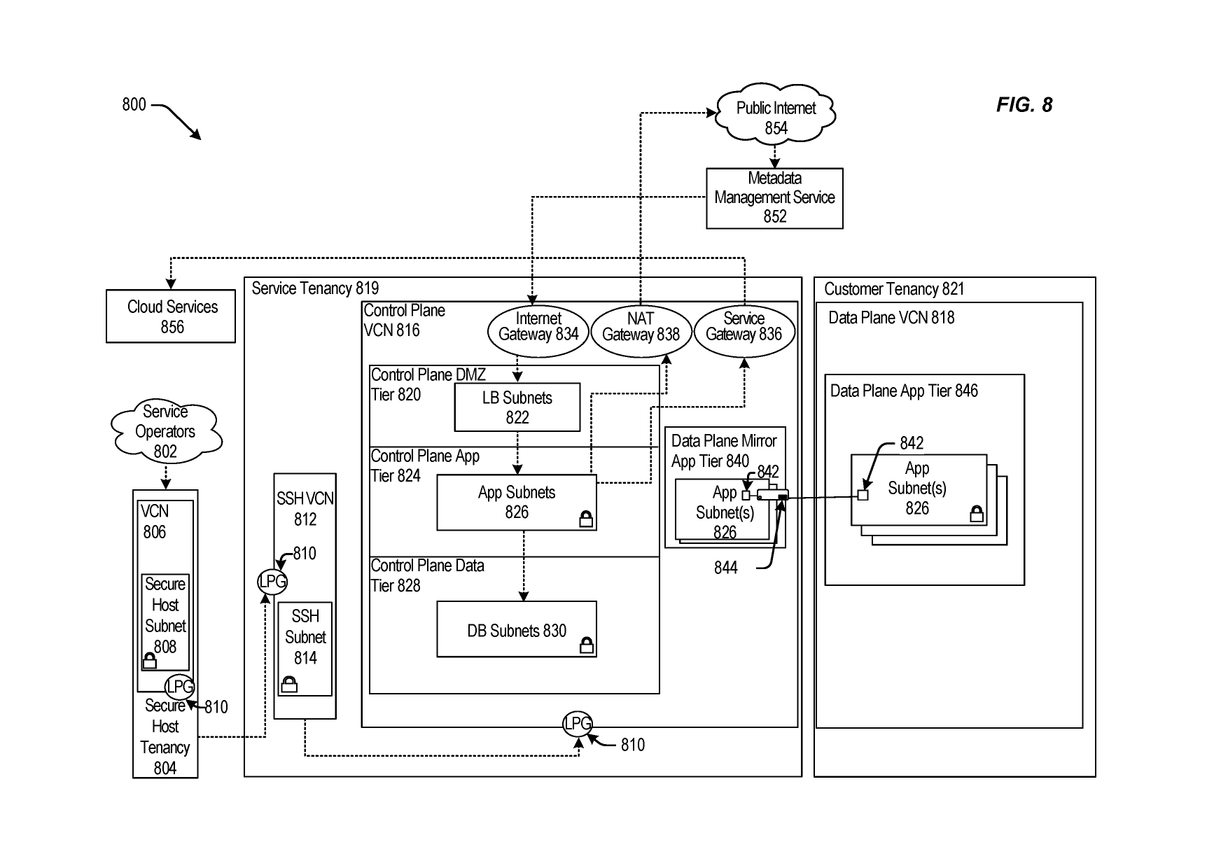

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

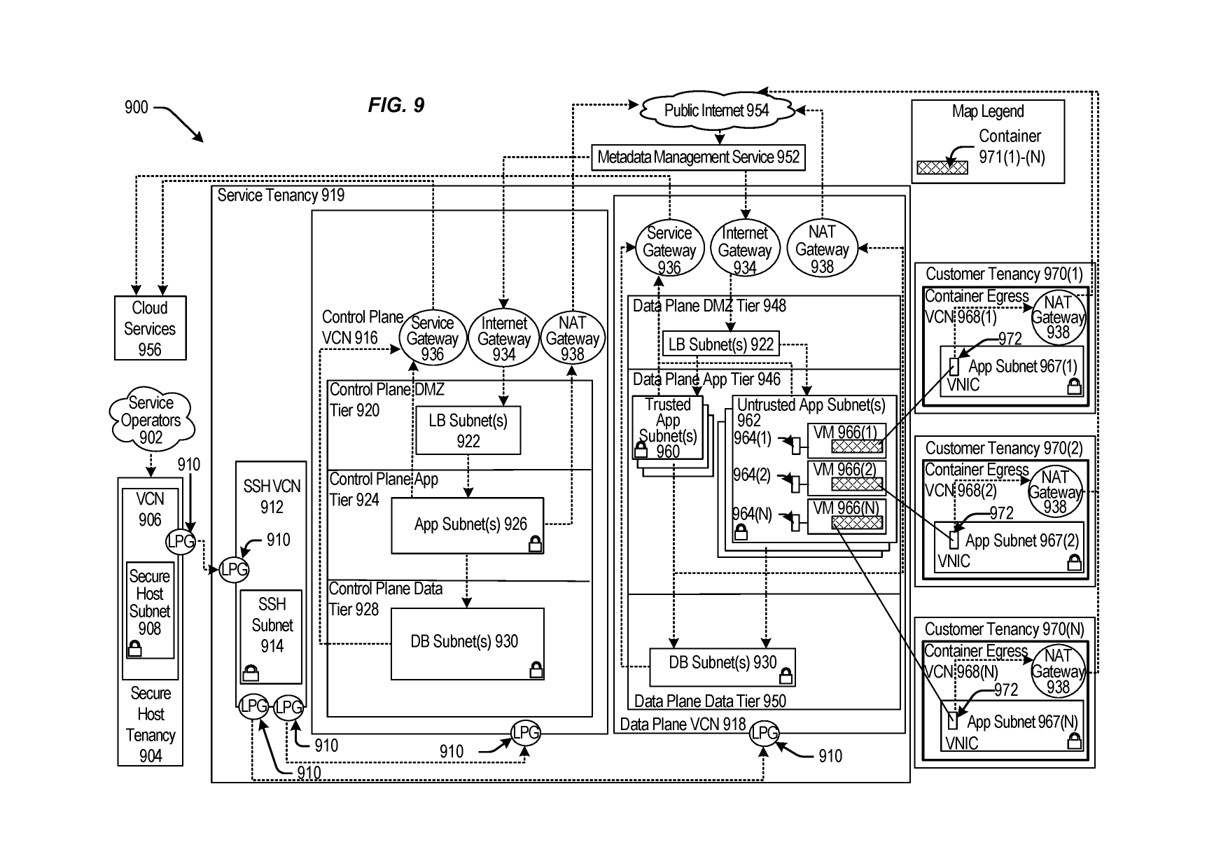

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

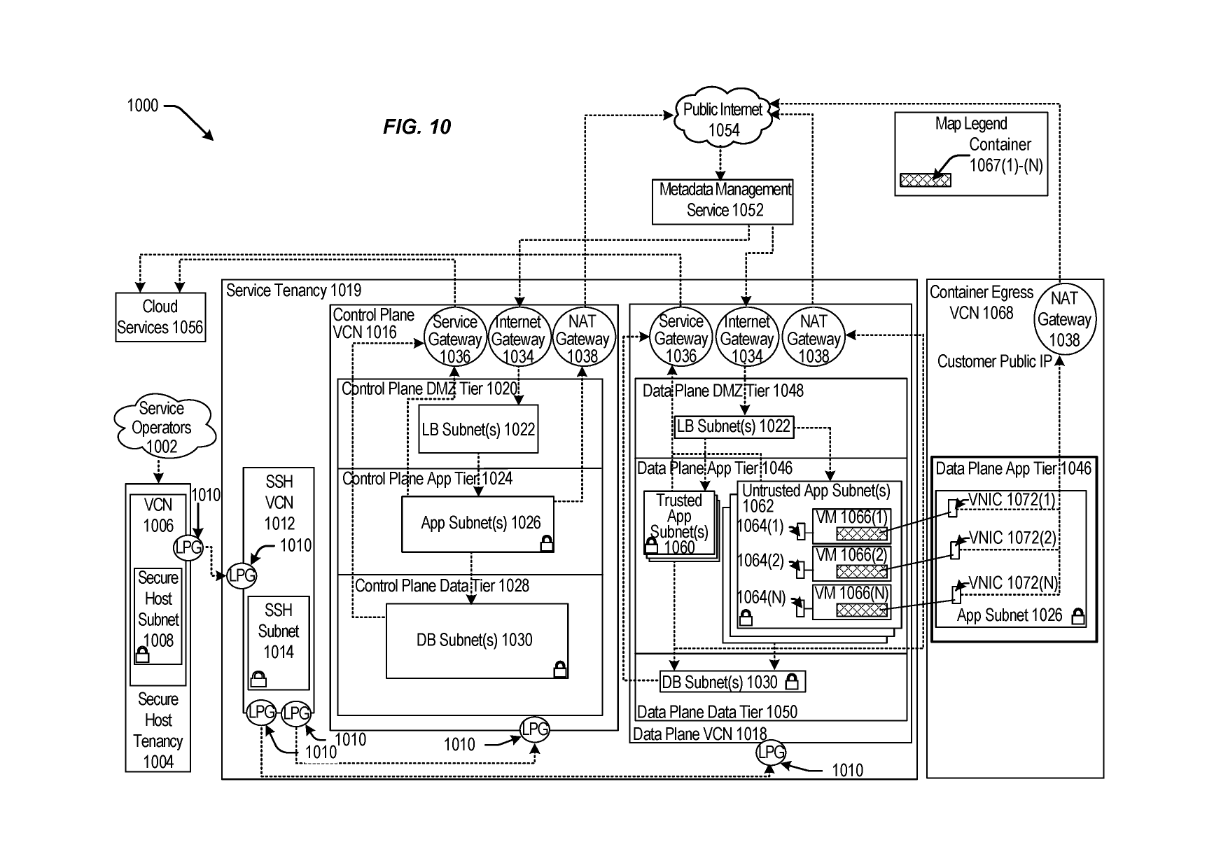

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N) and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

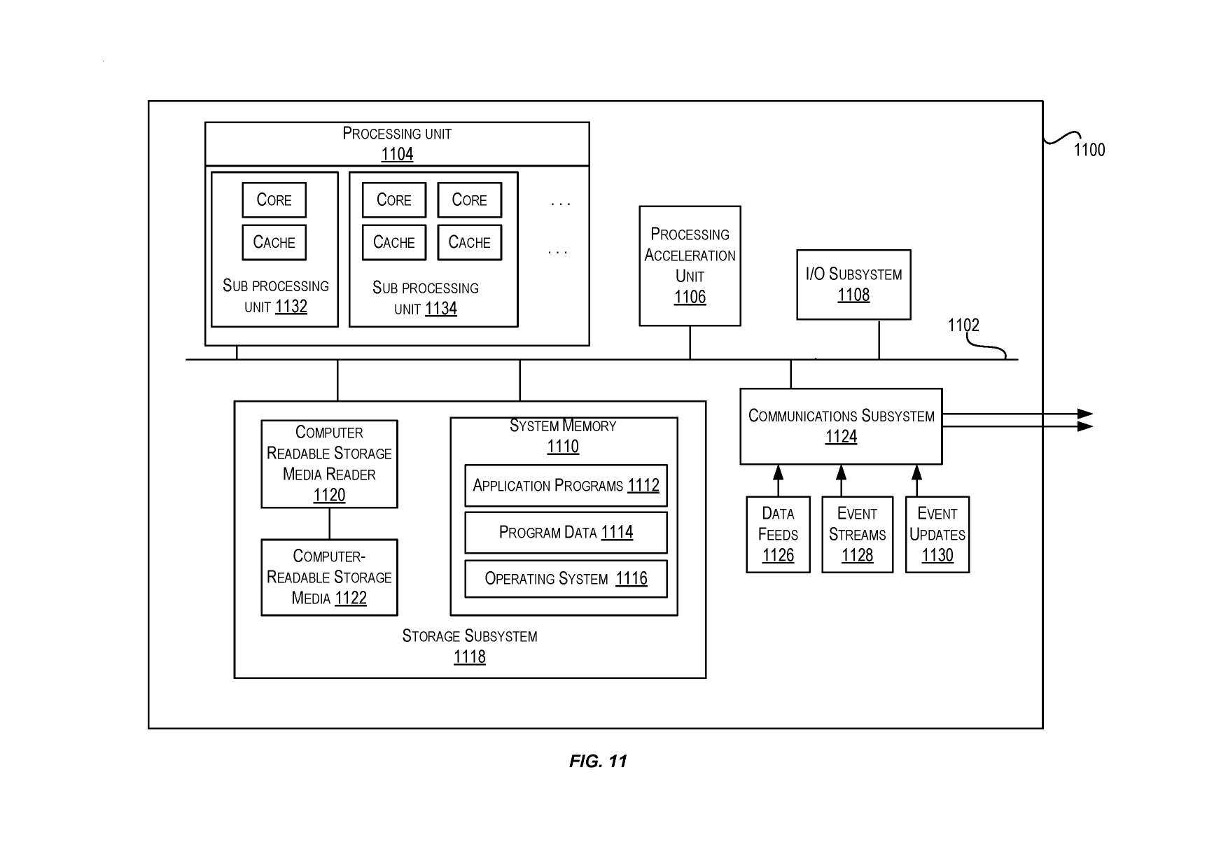

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term "output device" is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
providing, by the computing system to a voice generation system, input data comprising text and the audio sample corresponding to a first speaker;
obtaining, by the computing system from the voice generation system, machine-generated audio corresponding to the first speaker, the machine-generated audio being generated based at least in part on the text and the audio sample corresponding to the first speaker;
generating, by the computing system, a synthetic training data set comprising the text, the machine-generated audio generated by the voice generation system, and corresponding to the first speaker with an audio recording corresponding to a second speaker; and
training, by the computing system and based at least in part on the synthetic training data set, a multi-speaker Text-To-Speech model to generate audio output comprising speech corresponding to subsequent text provided as subsequent input data.

2. The computer-implemented method of claim 1, wherein the machine-generated audio is generated by the voice generation system using a machine learning model that is configured to generate, from written text, a digital replication of a speaker’s voice, the machine learning model being configured with voice cloning capabilities.

3. The computer-implemented method of claim 1, further comprising:
executing, by the computing system, a first set of operations that transform text of the synthetic training data examples into corresponding sets of sound units; and
executing, by the computing system, a second set of operations that generate a respective feature vector corresponding to a respective synthetic training data example of the synthetic training data examples, wherein the respective feature vector corresponding to the respective synthetic training data example is utilized for the training of the multi-speaker Text-To-Speech model.

4. The computer-implemented method of claim 1, further comprising:
executing, by the computing system, a first set of operations that transform text of the synthetic training data examples into corresponding sets of sound units; and
executing, by the computing system, a second set of operations that generate one or more prosody features of at least one audio sample of the synthetic training data examples, wherein the corresponding sets of sound units and prosody features are utilized for the training of the multi-speaker Text-To-Speech model.

5. The computer-implemented method of claim 1, further comprising providing, by the computing system to a machine-learning model, the machine-generated audio generated by the voice generation system and corresponding to the first speaker, the machine-learning model providing an audio sample duration corresponding to the machine-generated audio generated by the voice generation system and corresponding to the first speaker, wherein the audio sample duration is further utilized for the training of the multi-speaker Text-To-Speech model.

6. The computer-implemented method of claim 1, wherein the audio recording corresponding to the second speaker is one of a plurality of audio recordings corresponding to the second speaker, the audio recording comprising a voice of the second speaker reading a text passage aloud.

7. The computer-implemented method of claim 1, further comprising:
obtaining, by the computing system, one or more quality-related metrics corresponding to the audio output generated by the multi-speaker Text-To-Speech model based at least in part on being provided the subsequent input data;
determining, by the computing system that the one or more quality-related metrics indicate that the audio output generated by the multi-speaker Text-To-Speech model breaches a predefined quality threshold; and
performing, by the computing system, operations to update the multi-speaker Text-To-Speech model based at least in part on an additional training data example comprising the audio output generated by the multi-speaker Text-To-Speech model.

8. A system, comprising:
one or more processors; and
one or more non-transitory memories storing computer-readable instructions that, when executed, cause the one or more processors to:
provide, to a voice generation system, input data comprising text and the audio sample corresponding to a first speaker;
obtain, from the voice generation system, machine-generated audio corresponding to the first speaker, the machine-generated audio being generated based at least in part on the text and the audio sample corresponding to the first speaker;
generate a synthetic training data set comprising the text, the machine-generated audio generated by the voice generation system and corresponding to the first speaker with an audio recording corresponding to a second speaker; and
train, based at least in part on the synthetic training data set, a multi-speaker Text-To-Speech model to generate audio output comprising speech corresponding to subsequent text provided as subsequent input data.

9. The system of claim 8, wherein the machine-generated audio is generated by the voice generation system using a machine learning model that is configured to generate, from written text, a digital replication of a speaker’s voice, the machine learning model being configured with voice cloning capabilities.

10. The system of claim 8, wherein executing the computer-executable instructions further causes the one or more processors to:
execute a first set of operations that transform text of the synthetic training data examples into corresponding sets of sound units; and
execute a second set of operations that generate a respective feature vector corresponding to a respective synthetic training data example of the synthetic training data examples, wherein the respective feature vector corresponding to the respective synthetic training data example is utilized for the training of the multi-speaker Text-To-Speech model.

11. The system of claim 8, wherein executing the computer-executable instructions further causes the one or more processors to:
execute a first set of operations that transform text of the synthetic training data examples into corresponding sets of sound units; and
execute a second set of operations that generate one or more prosody features of at least one audio sample of the synthetic training data examples, wherein the corresponding sets of sound units and prosody features are utilized for the training of the multi-speaker Text-To-Speech model.

12. The system of claim 8, wherein executing the computer-executable instructions further causes the one or more processors to provide, to a machine-learning model, the machine-generated audio generated by the voice generation system and corresponding to the first speaker, the machine-learning model providing an audio sample duration corresponding to the machine-generated audio generated by the voice generation system and corresponding to the first speaker, wherein the audio sample duration is further utilized for the training of the multi-speaker Text-To-Speech model.

13. The system of claim 8, wherein the audio recording corresponding to the second speaker is one of a plurality of audio recordings corresponding to the second speaker, the audio recording comprising a voice of the second speaker reading a text passage aloud.

14. The system of claim 8, wherein executing the computer-executable instructions further causes the one or more processors to:
obtain one or more quality-related metrics corresponding to the audio output generated by the multi-speaker Text-To-Speech model based at least in part on being provided the subsequent input data;
determine that the one or more quality-related metrics indicate that the audio output generated by the multi-speaker Text-To-Speech model breaches a predefined quality threshold; and
perform operations to update the multi-speaker Text-To-Speech model based at least in part on an additional training data example comprising the audio output generated by the multi-speaker Text-To-Speech model.

15. A computer-readable medium comprising one or more memories storing computer-readable instructions that, when executed by one or more processors of a computing device, cause the one or more processors to:
provide, to a voice generation system, input data comprising text and the audio sample corresponding to a first speaker;
obtain, from the voice generation system, machine-generated audio corresponding to the first speaker, the machine-generated audio being generated based at least in part on the text and the audio sample corresponding to the first speaker;
generate a synthetic training data set comprising the text, the machine-generated audio generated by the voice generation system and corresponding to the first speaker with an audio recording corresponding to a second speaker; and
train, based at least in part on the synthetic training data set, a multi-speaker Text-To-Speech model to generate audio output comprising speech corresponding to subsequent text provided as subsequent input data.

16. The computer-readable medium of claim 15, wherein the machine-generated audio is generated by the voice generation system using a machine learning model that is configured to generate, from written text, a digital replication of a speaker’s voice, the machine learning model being configured with voice cloning capabilities.

17. The computer-readable medium of claim 15, wherein executing the computer-executable instructions further causes the one or more processors to:
execute a first set of operations that transform text of the synthetic training data examples into corresponding sets of sound units; and
execute a second set of operations that generate a respective feature vector corresponding to a respective synthetic training data example of the synthetic training data examples, wherein the respective feature vector corresponding to the respective synthetic training data example is utilized for the training of the multi-speaker Text-To-Speech model.

18. The computer-readable medium of claim 15, wherein executing the computer-executable instructions further causes the one or more processors to:
execute a first set of operations that transform text of the synthetic training data examples into corresponding sets of sound units; and
execute a second set of operations that generate one or more prosody features of at least one audio sample of the synthetic training data examples, wherein the corresponding sets of sound units and prosody features are utilized for the training of the multi-speaker Text-To-Speech model.

19. The computer-readable medium of claim 15, wherein executing the computer-executable instructions further causes the one or more processors to provide, to a machine-learning model, the machine-generated audio generated by the voice generation system and corresponding to the first speaker, the machine-learning model providing an audio sample duration corresponding to the machine-generated audio generated by the voice generation system and corresponding to the first speaker, wherein the audio sample duration is further utilized for the training of the multi-speaker Text-To-Speech model.

20. The computer-readable medium of claim 15, wherein the audio recording corresponding to the second speaker is one of a plurality of audio recordings corresponding to the second speaker, the audio recording comprising a voice of the second speaker reading a text passage aloud.
